(19) United States
(12) Patent Application Publication
(10) Pub. No.: US 2005/0123166 A1
(43) Pub. Date: Jun. 9, 2005

(54) Structure of speaker

(76) Inventors: Lee-Long Chen, Taoyuan County (TW); Chen-Feng Wu, Taoyuan County (TW); Ming Yeh, Taoyuan County (TW)

Correspondence Address: BIRCH STEWART KOLASCH & BIRCH, PO BOX 747, FALLS CHURCH, VA, 22040-0747, US

(21) Appl. No.: 10/872,468

(22) Filed: Jun. 22, 2004

(30) Foreign Application Priority Data
Dec. 8, 2003 (TW) 092134569

(51) Int. Cl. H04R 1/00; H04R 25/00; H04R 9/06

(52) U.S. Cl. 381/412; 381/414

(57) ABSTRACT

A structure of speaker is disclosed. The disclosed speaker structure includes at least a bobbin, a coil, a membrane, and a magnetic assembly. The coil is wound around the side surface of the bobbin, and the membrane is disposed at end of the bobbin. Besides, the magnetic assembly is suspended in a through hole of the bobbin and have one end adhered to the membrane.

### BACKGROUND OF THE INVENTION

1. Field of the Invention

This invention relates to a sound generating device and, more particularly, to an improved structure of speaker.

2. Description of Related Art

In the development of various audio and video multimedia devices, the quality of audio signal is improving as well as that of video signals day by day. Notwithstanding the current technology can integrate magnificent sound signals, superior sound quality still needs a good speaker to perform. Since the sound of a multimedia audio and video equipment is produced by transforming an electric signal into a sound wave via a speaker, the speaker need to be improved to obtain sound signals in high quality.

As shown in FIG. 1, a conventional speaker 1 has an upper cover 11, a base 12, a permanent magnet 13, a coil 14 and a membrane 15. The permanent magnet 13 is mounted in a notch 121 of the base 12 with the poles distributed as shown in the diagram (N-pole on the top and S-pole at the bottom). The coil 14 is wound around the prefabricated groove 131 with the top surface thereof adhered to the membrane 15 by an adhesive. Furthermore, two external wires 141 extracted from the coil 14 are electrically connected to an external power supply (not shown).

In operation, when the terminals A and B of the two external wires 141 are connected respectively to the positive and negative electrode of the external power supply, the coil 14 has a polarity distribution in which the top half is N-pole and the bottom half is S-pole due to the electromagnetic induction. The magnetic force between the coil 14 and the permanent magnet 13 then forces the coil 14 to move upward and simultaneously makes the membrane 15 to move upward. Similarly, when the two terminals A and B of the external wires 141 are connected respectively to the negative and positive electrode of the external power supply, the coil 14 will have a polarity distribution in which the top half is S-pole and the bottom half is N-pole due to the electromagnetic induction. The magnetic force between the coil 14 and the permanent magnet 13 then forces the coil 14 to move downward and simultaneously makes the membrane 15 to move downward. Thus, by changing the current direction flowing through the coil 14, we can make the membrane 15 vibrate with various amplitudes in response to the electrical signals applied to the coil 14, and push the air to generate sound.

For this conventional speaker 1, since the coil 14 is mostly made up of self-adhesive wires having weak tensile strength, and vibrates together with the membrane 15, the coil 14 is quite easy to break during the vibration process and the life of the speaker is shortened.

As shown in FIG. 2, another conventional speaker 2 has an upper cover 20, a bottom cover 21, a ring type housing 22, a disk type magnet 23 with a magnetic pillar 231 extending upwardly from center, a ring type permanent magnet 24 with S-pole on the upper part and N-pole at the lower part, a membrane 25, a magnetic sheet 26, and a coil 27. The ring type permanent magnet 24 is mounted on the inner sidewall of the ring type housing 22, and the disk type magnet 23 is attached to the outer bottom face of the ring type housing 22. Besides, the coil 27 is wound along the cylindrical surface of the magnetic pillar 231, and the membrane 25 is mounted on the top face of the ring type housing 22 with a magnetic sheet 26 attached to the center section of the membrane 25. Moreover, two external wires 271 are extracted from the coil 27 to be connected to an external power supply (not shown).

In operation, when terminals A and B of the two external wires 271 are connected to the negative and positive electrodes, respectively, the coil 27 electro-magnetically inducts the magnetic pillar 231 to have a polarity distribution in which the top half is N-pole and the bottom half is S-pole. The magnetic force between the magnetic pillar 231 and the magnetic sheet 26 then pushes the membrane 25 to move downward. Similarly, when the two terminals A and B of the external wires 271 are connected respectively to the positive and negative electrode of the external power supply, the coil 27 electro-magnetically inducts the magnetic pillar 231 to have a polarity distribution in which the upper part is S-pole and the lower part is N-pole. The magnetic force between the magnetic pillar 231 and the magnet sheet 26 then pushes the membrane 25 to move upward. Thus, by changing the current direction flowing through the coil 27, we can make the membrane 25 to vibrate with various amplitudes in response to the electrical signals applied to the coil 27, and push the air to generate sound.

For this conventional speaker 2, however, since the magnetic sheet 26 mounted on top of the membrane 25 has only one polarity, the magnetic force between the magnetic sheet 26 and the magnetic pillar 231 is weak and makes the membrane 25 to vibrate with limited amplitudes. Therefore, the voice of the generated sound is limited.

In order to effectively improve the sound quality of audio and video multimedia equipment and to solve the above-mentioned problems, this invention discloses an improved speaker structure. The improved speaker structure is easy to manufacture and is low in the cost. It also effectively increases the efficiency of transforming electric signals to sound waves. The speaker structure can be used as sound generating devices in various multimedia equipments such as a mobile phone, notebook, and hi-fi equipment.

### BRIEF SUMMARY OF THE INVENTION

In view of the above-mentioned problems, one object of the invention is to provide a speaker structure that can effectively transform an electronic signal into a sound wave, and has longer life and increased sound output.

The speaker structure according to this invention includes at least a bobbin, a coil, a membrane, and a magnetic assembly. The coil is wound around the side surface of the bobbin, and the membrane is disposed at one end of the bobbin. The magnetic assembly is suspended in the through hole of the bobbin with one end thereof connected to the membrane.

In one of the embodiment, the polarity of an end of the magnetic assembly connected to the membrane is opposite to the polarity of the middle section of the magnetic assembly. Furthermore, the radial centerline of the magnetic assembly is in alignment with the radial centerline of the coil. In addition, the length above (or beneath) the centerline of the coil is greater than the half-length above (or beneath) the centerline of the magnetic assembly and less than the length above (or beneath) the centerline of the magnetic assembly.

One of the advantages of the speaker structure of the invention is the ease of manufacturing and assembly. Besides, the coil has sufficient winding space, and does not break during operation process. Furthermore, the magnetic force derived can generate loud sound and the vibration level of the magnetic assembly is uniform. Also, the speaker structure is adaptable to large-scale and micro-scale speaker.

### BRIEF DESCRIPTION OF THE DRAWINGS

FIG. 1 is a sectional diagram illustrating a conventional speaker structure.

FIG. 2 is a sectional diagram illustrating another conventional speaker structure.

FIG. 3A is a sectional diagram illustrating speaker structure according to one embodiment of the invention.

FIG. 3B is a schematic diagram illustrating the magnetic force action between the magnetic assembly and the coil of the speaker structure shown in FIG. 3A in a first condition.

FIG. 3C is a schematic diagram illustrating the magnetic force effect between the magnetic assembly and the coil of the speaker structure shown in FIG. 3A in a second condition.

FIG. 4 is a sectional diagram illustrating speaker structure according to another embodiment of the invention.

### DETAILED DESCRIPTION OF THE INVENTION

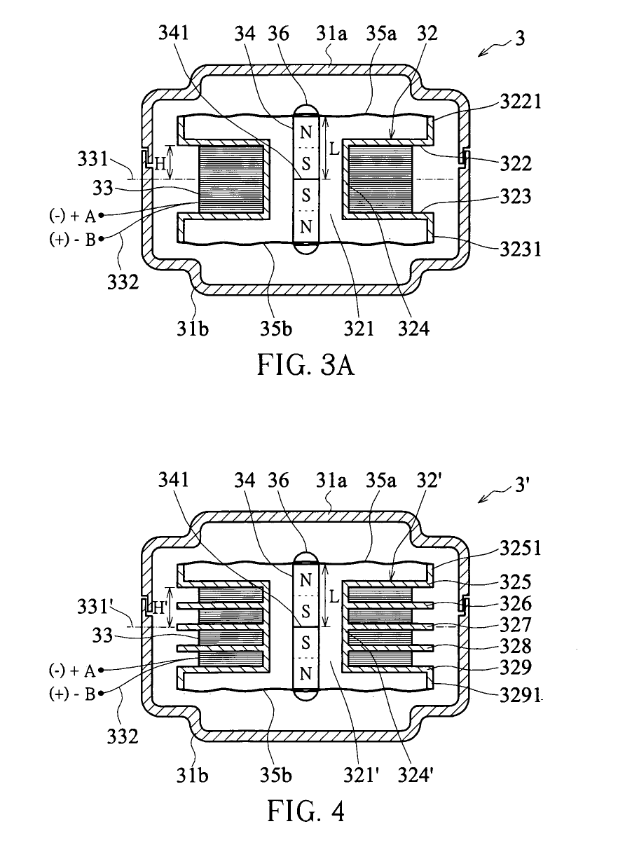

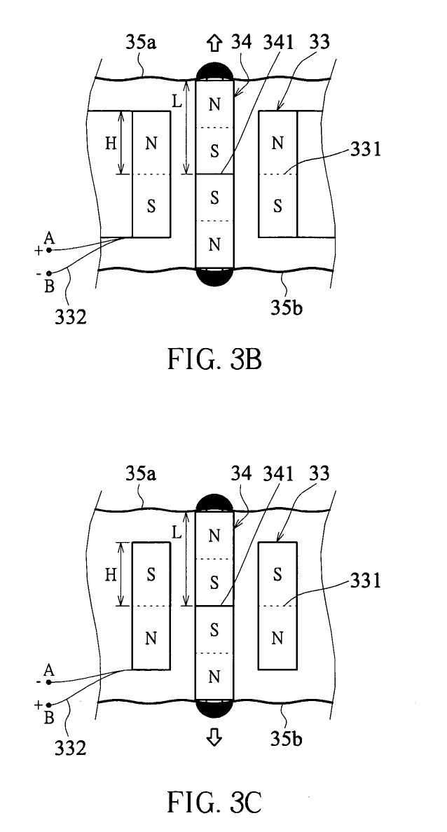

As shown in FIG. 3A, a speaker structure 3 of the first embodiment of the invention includes an upper housing 31a and lower housing 31b, a bobbin 32, a coil 33, a magnetic assembly 34 and two membranes 35a and 35b. The upper housing 31a, lower housing 31b, and the bobbin 32 are made of plastics. The magnetic assembly 34 can be made from materials such as permanent magnet or other materials with magnetism such as plastic magnet.

The bobbin 32 has a through hole 321 and two partition surfaces 322 and 323 extending outwardly in radial from the outer side surface 324. Furthermore, the partition surfaces 322 and 323 extend upwards and downwards to form flanges 3221 and 3231, respectively. The coil 33 is wound on the outside surface 324 of the bobbin 32 and between the two partition surfaces 322 and 323. Furthermore, two external wires 332 are extracted from the coil 33 to be connected to an external power supply. Two membrane 35a and 35b are disposed at upper and lower ends of the bobbin 32 and fixed to the flanges 3221 and 3231, respectively, and there exists a gap between the partition surface 322 (323) and its corresponding membrane 35a (35b). Besides, the magnetic assembly 34 is suspended in the through hole 321 and both ends thereof are connected to the two membranes 35a and 35b, respectively.

On the other hand, the polarities of both ends of the magnetic assembly 34 connecting to the membranes 35a and 35b are the same but opposite to the polarity of the middle section. In this embodiment, the magnetic assembly 34 is formed by stacking two permanent magnets with the N-pole connected to N-pole and S-pole connected to S-pole. As a result, the polarity of the top and bottom ends of the magnetic assembly 34 are both N-pole, and the middle section is S-pole. In addition, to ensure the magnetic force arisen between the magnetic assembly 34 and the coil 33 can bring out the expected effect, the radial centerline 341 of the magnetic assembly 34 is in alignment with the radial centerline 331 of the coil 33. Besides, the length H above (or beneath) the centerline 331 of the coil 33 must be greater than half of the length L above (or beneath) the centerline 341 of the magnetic assembly 34 and less than the length L above (or beneath) the centerline 341 of the magnetic assembly 34. That is, L/2<H<L.

In this embodiment, each of the permanent magnets forming the magnetic assembly 34 has a through hole in the center (not shown). Which is to connect all permanent magnets forming the magnetic assembly 34 with the two membranes 35a and 35b using rivets 36. This method can form a secure connection between the magnetic assembly 34 and the two membranes 35a and 35b to prevent them from breaking away during vibrating process. In addition to this method, the magnetic assembly 34 can also be adhered to the membranes 35a and 35b using an adhesive.

As shown in FIG. 3B, when the terminals A and B of the two external wires 332 of the coil 33 are connected respectively to a positive and a negative electrodes of an external power supply, the coil 33 generates a magnetic field with the upper half being N-pole, and the lower half being S-pole. The radial centerline 341 of the magnetic assembly 34 is in alignment with the radial centerline 331 of the coil 33. The length H above the centerline 331 of the coil 33 is greater than half of the length L above the centerline 341 of the magnetic assembly 34. Therefore, the magnetic force arisen between the magnetic field of the coil 33 and the magnetic assembly 34 pushes the magnetic assembly 34 to move upward and simultaneously makes the membrane 35a to move upward. Likewise, referring to FIG. 3C, when the terminals A and B of the two external wires 332 of the coil 33 are connected respectively to a negative and a positive electrodes of an external power supply, the coil 33 generates a magnetic field with the upper half being S-pole, and lower half being N-pole. The magnetic force arisen between the magnetic field and the magnetic assembly 34 pushes the magnetic assembly 34 to move downward and simultaneously makes the membrane 35a to move downward.

By changing the polarity of the electrodes connecting to the two terminals A and B of the two external wires 332 of the coil 33, the magnetic assembly 34 is made to vibrate in the through hole 321 of the bobbin 32 and push the membrane 35a and 35b to vibrate and push the air to generate sound.

As shown in FIG. 4, the speaker 3′ according to second embodiment of the invention has a different bobbin 32′ from the one in the first embodiment of the invention. However, the rests are the same and will not be described again hereafter.

In this embodiment, the bobbin 32′ has a through hole 321 to accommodate the magnetic assembly 34. It also has partition surfaces 325, 326, 327, 328 and 329 extending outwardly in radial from the outer side surface 324′. Furthermore, the partition surfaces 325 and 329 extend upwards and downward to form flanges 3251 and 3291 respectively. The coil 33 is wound around the outside surface 324′ of the bobbin 32′ in sections between partition surfaces 325 and 326, between partition surfaces 326 and 327, between partition surfaces 327 and 328,and between partition surfaces 328 and 329. Furthermore, there are two external wires 332 extracted from the coil 33 to be connected to an external power supply. The two membranes 35a and 35b are disposed at the two ends of the bobbin 32 and are fixed to the flanges 3251 and 3291. Therefore, there exists a gap between the partition surface 325 (329) and its corresponding membrane 35a (35b). In addition, the magnetic assembly 34 is suspended in a through hole 321′ with its upper and lower ends connected to two membranes 35a and 35b respectively.

Besides, the radial centerline 341 of the magnetic assembly 34 is in alignment with the radial centerline 331′ of the coil 33. In addition, the length H′ above (or beneath) the centerline 331′ of the coil 33 is greater than half of the length L above (or beneath) the centerline 341 of the magnetic assembly 34, and is less than the length L above (or beneath) the centerline 341 of the magnetic assembly 34.

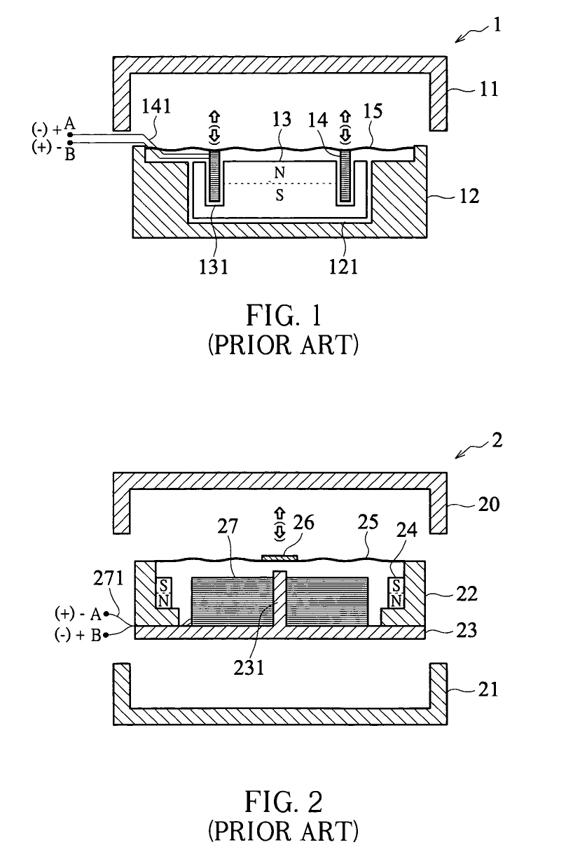

In comparison with the conventional speaker shown in FIG. 2, the area for magnetic action lines between the magnetic assembly 34 and the coil 33 to pass through is bigger for the speaker structure in each of the embodiments of the invention. This provides sufficient magnetic force to increase the amplitude of vibration of the membrane 35a and 35b to generate loud sound. Furthermore, in comparison with the conventional speaker shown in FIG. 1, the coil 33 used in the speaker structure of the invention is motionless and thus prevents itself from breaking during the vibration process.

To sum up, the invention has been disclosed with illustrative embodiments described hereinbefore. These embodiments are used to exemplify but not to limit the invention. Therefore, any changes and modifications of the speaker structure without departing from the substantial spirit and scope are considered to lie within the scope of the invention as defined by the appended claims.

1. A speaker structure, comprising:
a bobbin having a through hole;
a coil wound around outside surface of the bobbin;
a membrane disposed at an end of the bobbin; and
a magnetic assembly suspended in the through hole and having one end adhered to the membrane.

2. The speaker structure of claim 1, wherein a radial centerline of the magnetic assembly is in alignment with a radial centerline of the coil.

3. The speaker structure of claim 2, wherein a length above the centerline of the coil is less than a length above the centerline of the magnetic assembly, and is greater than half the length above the centerline of the magnetic assembly.

4. The speaker structure of claim 1, wherein at least two wires of the coil are extracted to connect to an external power supply.

5. The speaker structure of claim 1, wherein a polarity of the end of the magnetic assembly connecting to the membrane is opposite to a polarity of a middle section of the magnetic assembly.

6. The speaker structure of claim 1, wherein the magnetic assembly is formed by a plurality of magnets with N- and S-pole, wherein N-pole joins N-pole, and S-pole joins S-pole.

7. The speaker structure of claim 6, wherein the magnets are permanent magnets.

8. The speaker structure of claim 1, wherein the magnetic assembly is either riveted with or adhered to the membrane.

9. A speaker structure, comprising:
a bobbin having a plurality of partition surfaces, a side surface, and a through hole;
a coil wound among the partition surfaces and the side surface of the bobbin in segment;
two membranes disposed at both ends of the bobbin, respectively; and
a magnetic assembly suspended in the through hole with both ends adhered to the membranes respectively;
wherein the partition surfaces are formed by extending from the side surface radially and outwardly.

10. The speaker structure of claim 9, wherein a radial centerline of the magnetic assembly is in alignment with a radial centerline of the coil.

11. The speaker structure of claim 10, wherein a length above the centerline of the coil is less than a length above the centerline of the magnetic assembly, and is greater than half the length above the centerline of the magnetic assembly.

12. The speaker structure of claim 9, wherein at least two wires of the coil are extracted to be connected to an external power supply.

13. The speaker structure of claim 9, wherein polarity of the ends of the magnetic assembly connected to the membranes are opposite to polarity of the middle section of the magnetic assembly.

14. The speaker structure of claim 9, wherein the magnetic assembly is formed by a plurality of magnets with N- and S-pole, wherein N-pole joins N-pole and S-pole joins S-pole.

15. The speaker structure of claim 14, wherein the magnets are permanent magnets.

16. The speaker structure of claim 9, wherein flanges are formed on the partition surfaces adjacent to the membranes.

17. The speaker structure of claim 9, wherein the magnetic assembly is riveted with or adhered to the membranes.
